(19) United States
(12) Patent Application Publication
(10) Pub. No.: US 2003/0004801 A1
(43) Pub. Date: Jan. 2, 2003

(54) Method and apparatus for pairing discounts

(75) Inventor: Nobuko Oda, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 09/983,111

(22) Filed: Oct. 23, 2001

(30) Foreign Application Priority Data
Jun. 27, 2001 (JP) 2001-194485

(51) Int. Cl. G06F 17/60

(52) U.S. Cl. 705/14; 705/26

(57) ABSTRACT

A method used for pairing discounts is provided, in which the method includes the steps of: receiving a first offer of a first discount from a first store; receiving a second offer of a second discount from a second store; pairing the first discount and the second discount, and registering a pair of the first discount and the second discount in a storing part; and allowing a user who bought a commodity in the first store to receive a discount in the second store on the basis of information of the pair.

### BACKGROUND OF THE INVENTION

1. Field of the Invention

The present invention relates to a method of pairing discounts of a plurality of stores.

2. Description of the Related Art

Recently, large complex supermarkets open stores at many places in which the supermarket deal in general commodities from foods and clothing to household electrical appliances in a building. Thus, in order to compete against the large complex supermarkets, retail stores each of which deal in commodities of one category in a local shopping street need to cooperate to carry out sales promotion.

As the sales promotion performed by a plurality of retail stores cooperativly, a sale is conducted by retail stores in a shopping street or in a same area. Generally, each retail store in the shopping street carries out discounts over a period of time, for example, as a year-end sale.

In addition, sales promotion using the Internet has been increasing recently. As the sales promotion using the Internet, introduction and advertisement of commodities are carried out on a homepage. In addition, a coupon is provided in a homepage such that a user prints out the coupon and brings it to a store in order to receive a discount.

However, since each retail store sets its own discount price when a discount sale is carried out in an area or in a shopping street, the discount sale does not encourage a user who bought a commodity in a retail store to buy a commodity in another retail store in the same shopping street. Therefore, it does not lead to invigorating the whole shopping street.

This problem also arises when the method of distributing a discount coupon in the Internet is adopted. That is, although sales promotion for each retail store in the Internet can be carried out, it does not lead to invigorating a whole shopping mall.

### SUMMARY OF THE INVENTION

An object of the present invention is to provide a method of pairing discounts in which sales promotion can be performed by the whole retail stores in an area while maintaining sales strategy of each retail store.

The above object can be achieved by a method used for pairing discounts on a network, the method including the steps of:

receiving a first offer of a first discount from a first store;

receiving a second offer of a second discount from a second store; and

pairing the first discount and the second discount, and registering a pair of the first discount and the second discount in a storing part.

According to the above-mentioned invention, a pair of discounts can be registered so that the pair can be used for providing a discount.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram of a system for realizing the present invention;

FIG. 2 shows data in a store master 11;

FIG. 3 shows data in a priority master 12;

FIG. 4 shows discount data 13;

FIG. 5 is a flowchart for explaining the operation of a server 1;

FIG. 6 is a flowchart for explaining the operation of a matching program;

FIG. 7 is a flowchart for explaining the operation of a client;

FIG. 8 is a flowchart for explaining the operation of a client;

FIG. 9 is an example of a screen for discount offer.

### DETAILED DESCRIPTION OF THE PREFERRED EMBODIMENTS

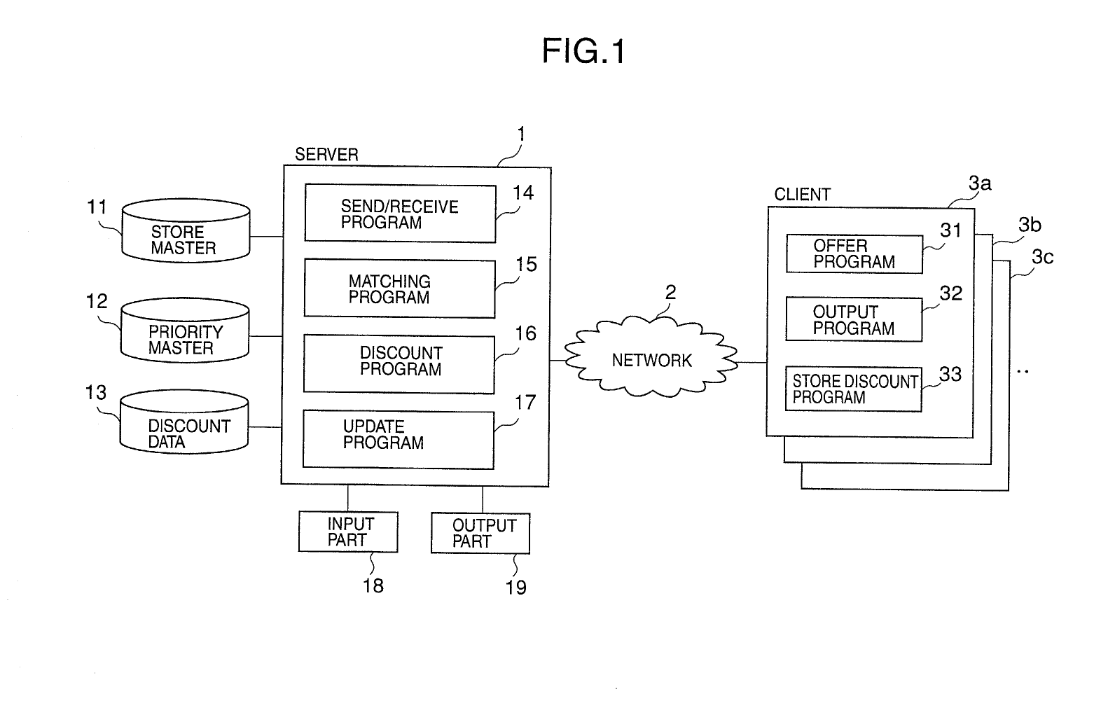

In the following, an embodiment of the present invention will be described with reference to figures. FIG. 1 shows a block diagram of a system for realizing the present invention. As shown in the figure, the system includes a server computer 1 (which will be called a server 1 hereinafter), a client computer 3a (which will be called a client 3a hereinafter) which is placed in a store side, and a network 2 such as the Internet which connects the server 1 and the client 3a. Clients 3b and 3c which have the same configuration as the client 3a are placed in other stores respectively. The server 1 is connected to each client in a store. Although the number of the clients is three in the example of FIG. 1, the number is not limited to three.

The server 1 includes a store master 11, a priority master 12, discount data 13 and a send/receive program 14, a matching program 15, a discount program 16, an update program 17, an input part 18 and an output part 19.

The client 3a includes an offer program 31, an output program 32, and a store discount program 33. In addition, the client 3a includes an input part and an output part which are not shown in the figure. Each of the clients 3b and 3c has the same configuration of the client 3a.

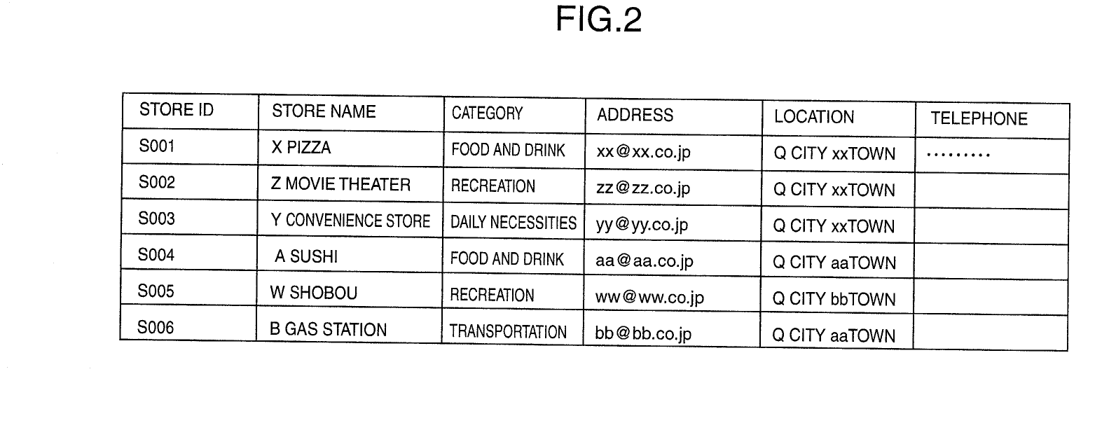

The store master 11 in the server 1 is a file for managing information on a plurality of stores connected to the server 1 via the network 2. As shown in FIG. 2, the store master 11 includes store IDs for identifying each store uniquely, store names, store categories which are determined by commodities dealt by each store, e-mail addresses used for the server 1 to connect to each store, locations of stores, and telephone numbers of the stores and the like.

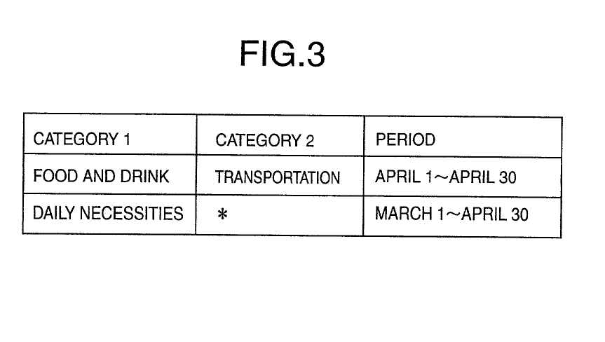

The priority master 12 is a file used for setting priorities for pairing a discount offer sent from a client with another offer. As shown in FIG. 3, the priority master 12 includes a category 1, category 2, and information on discount period. The category 1 and the category 2 correspond to categories of the store master 11. This means that a discount offer from a store of the category 1 and a discount offer from a store of the category 2 are paired preferentially.

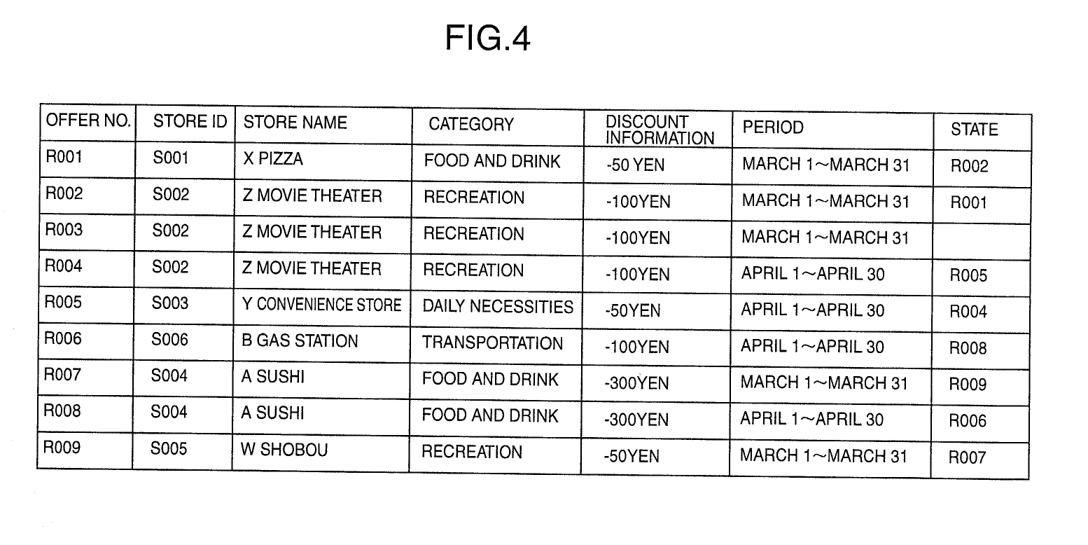

The discount data 13 is used for managing discount offers from clients and for managing discount pairs. As shown in FIG. 4, the discount data 13 includes offer numbers for identifying discount offers uniquely, store IDs, store names, categories, discount information, discount periods during which a discount is allowed, states which indicate discount pairing states. The store ID, the store name, and the category correspond to those of the store master 11 respectively. Each of the states includes an offer No. which corresponds to another offer which is paired with the corresponding offer. When the state is blank, it means that any pair is not established for the offer.

Each store can request a plurality of discounts in a same period. For example, a store S002 sent discount offers “R002” and “R003” as shown in FIG. 4 in which the discount offers have the same discount period. If a pair of discounts is established for each of such offers from the same store, the store can be paired with a plurality of stores in the same period.

The send/receive program 14 in the server 1 receives a discount offer from clients 3a-3c via the network 2, and sends information on a result of establishing a pair of discounts, inability of pairing, and allowance of discount.

The matching program 15 sets a pair of discounts by referring to discount offers registered in the discount data 13 and to the priority master 12.

The discount program 16 sends information on discount permission to the clients 3a- 3c with reference to discount pairs established by the matching program 15 via the send/receive program 14. In addition, the discount program 16 judges whether a discount is allowed when a client asks about availability of discount, and sends the result of judgment via the send/receive program 14.

The input part 18 provides data and instructions to the server 1. For example, the input part 18 is a device connected to a computer for data input such as a keyboard and a mouse. The output part 19 is a device for output connected to a computer such as a display and a printer.

The server 1 communicates with each of the clients 3a-3c at the store side in which the server 1 receives discount offers sent from clients, registers a pair of discounts, sends the pair of discounts to stores, and sends permission of discount.

The offer program 31 of the client 31a sends a discount offer of the store to the server 1 via the network 2.

The output program 32 outputs a coupon for notifying a user who bought in a store of a discount according to information on discount permission and a pair of discounts which is sent from the server 1 via the network 2. In addition, the output program 32 may provide information of discount on a receipt.

The store discount program 33 receives information on discount permission or a pair of discounts from the server 1 via the network 2, and makes an inquiry about whether discount is available to the server 1.

According to the above-mentioned configuration, the client 3a communicates with the server 1, sends a discount offer of a store, receives information on a discount pair which is decided in the server 1. In addition, the client 3a issues a coupon or a receipt on which discount information is provided for a user who buys a commodity in a store.

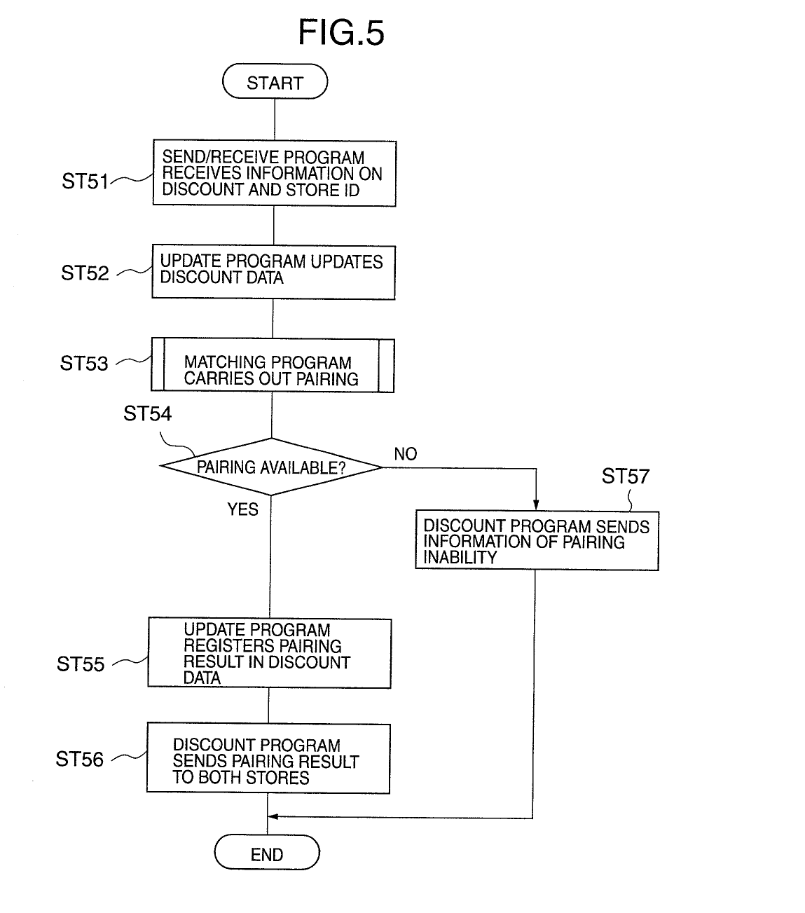

An example of the operation of the present invention will be described with reference to flowcharts of FIGS. 5-8.

FIG. 5 is a flowchart for explaining the operation of the server 1.

In step 51, the send/receive program 14 of the server 1 receives information on a discount, which is a discount offer, such as a store ID of a store which provides the discount, a discount price and a discount period from the offer program of the client 3a. The information received by the send/receive program 14 is added to the discount data 13 by the update program 17 in step 52.

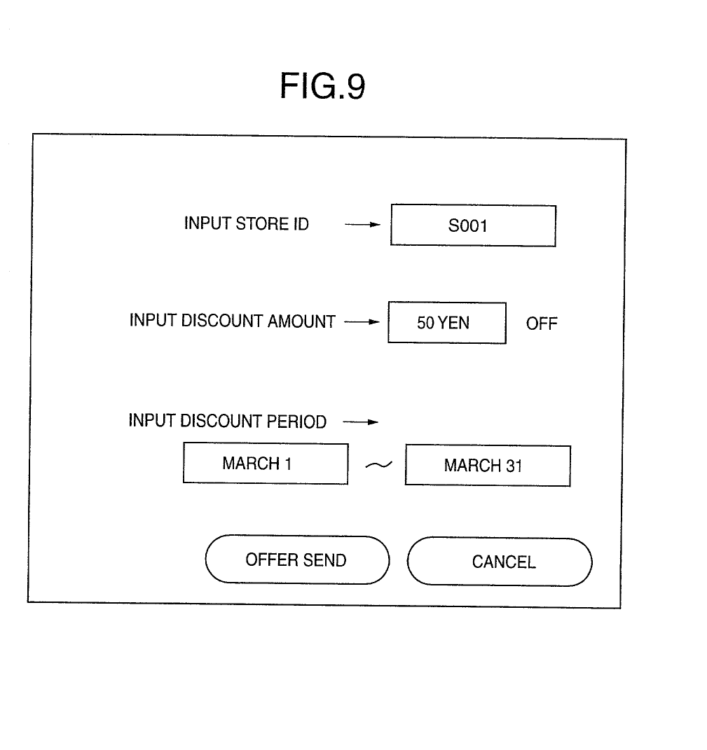

For example, when the server 1 has a function of a web server, the server 1 sends screen data for offering a discount as shown in FIG. 9, for example, to the client 3a in response to an offer screen output request sent from the offer program 31 to the server 1. For example, when the client 3a sends a discount offer which includes “S001” as the store ID, “50 yen” as the discount price, and “March 1-March 31” as the discount period, the send/receive program 14 receives this information.

The update program 17 refers to the store ID in the received information, searches the store master 11 by using the store ID as a key so as to obtain information on the store. For example, when receiving a discount offer shown in FIG. 9, since the store ID is “S001”, the update program refers to store ID field of the store master 11, and obtains information that the store name is “X pizza” and the category is “food and drink”. Then, the update program registers a newly generated offer No., for example, “R001”, to the discount data 13 as a new data, and copies the store ID, the store name and the category from information of the store ID field of the store master 11 and registers this information. In addition, the update program 17 refers to the discount price and the discount period from the received information. Then, the update program 17 registers the discount price “50 yen” to a discount information field in the discount data 13, and the discount period “March 1-March 31” to a period field in the discount data 13. Since a process of pairing discounts is not performed yet when the offer is just received, the state field in the discount data 13 remains blank.

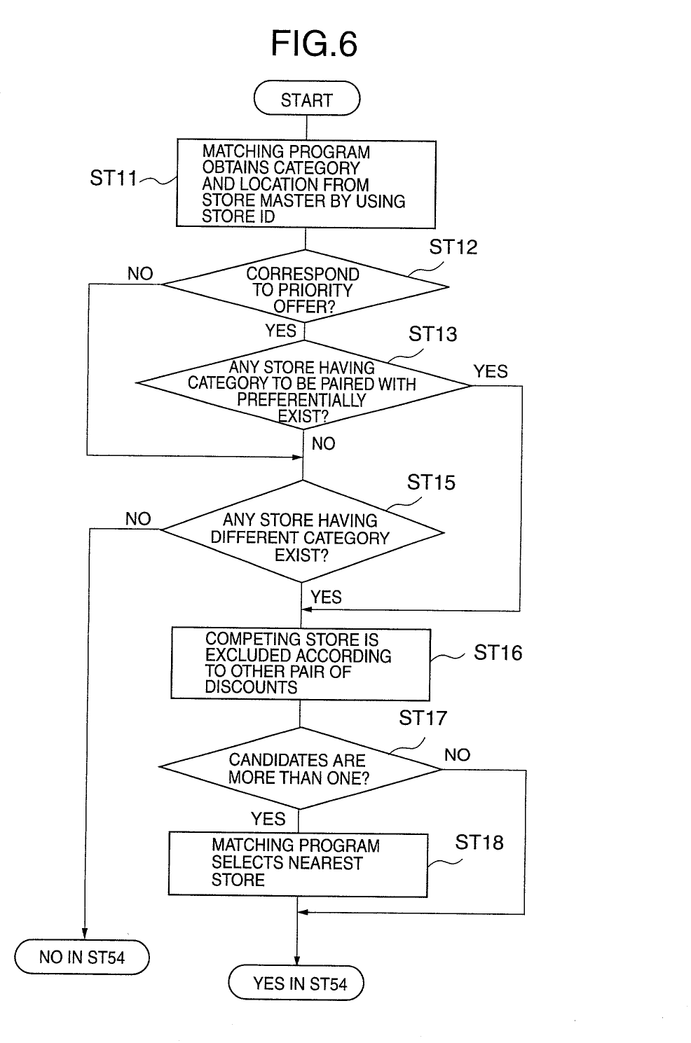

Next, in step 53, the matching program 15 performs a pairing process for a offered discount on the basis of the discount data 13 so that a discount pair is established. Details of the pairing process will be described later with reference to FIG. 6.

In step 54, the result of the pairing process in step 53 is judged. When a discount pair is established, the process goes to step 55. When any discount pair is not established, the process goes to step 57.

When pairing is available, the update program 17 registers the result of the pairing process in the discount data 13. For example, as shown in FIG. 4, when a pair of “R001” and “R002” is established, “R002” is registered in the state field of R001, and “R001” is registered in the state field of R002.

Then, in step 56, the discount program 16 instructs the send/receive program 14 to send information indicating that the discount pair is established to a store which corresponds one of the pair which offered the discount and to another store in the pair. The send/receive program 14 sends information indicating that the discount pair is established to each client of the paired stores via the network 2.

More precisely, the discount program 16 obtains the discount pair and store IDs of the paired stores by referring to the discount data 13 updated by the update program 17. Then, the discount program 16 obtains e-mail addresses corresponding to the stores of the pair from the store master 11 by using the store IDs, and passes the information to the send/receive program 14 with a send instruction. The send/receive program 14 sends the information indicating that the discount pair is established to each of the e-mail addresses.

When it is judged that the discount pair can not be established in step 54, the process goes to step 57. The discount program 16 instructs the send/receive program 14 to notify the store which offered the discount that any discount pair can not be established and the discount offer is reserved. The send/receive program 14 notifies the client of the store of this information.

More precisely, the discount program 16 obtains the store ID of the store by which any pair is not established from the discount data 13. Then, the discount program 16 obtains the e-mail address of the store by referring to the store master 11 on the basis of the store ID, and passes this information to the send/receive program 14 with a send instruction. The send/receive program 14 which receives the send instruction sends information indicating that the discount pair is not established and the discount offer is reserved for the store corresponding to the e-mail address.

The notification on establishment of a discount pair may be performed only when a pair is established. In such a case, when it is judged that a pair can not be established in step 54, the process ends at the time.

Next, the pairing process performed by the matching program in step 53 will be described with reference to FIG. 6.

First, in step 11, the matching program 15 refers to the store master 11 to obtain information on a category and a location of a store which sent a discount offer by using a store ID which is included in the discount offer. For example, when the offer is like that shown in FIG. 9, the matching program obtains information that the category is “food and drink” and the location is “Q city xx town” from the store master 11 on the basis of “S001” which is the store ID.

In step 12, the matching program 15 refers to the priority master 12 which is registered beforehand so that the matching program 15 judges whether the received offer corresponds to information in the priority master 12 on the basis of information which is newly registered in the discount data 13 by the update program 17.

For example, in the case of the offer of FIG. 9, when information shown in FIG. 3 is registered in the priority master 12, it is judged whether priority information including both of category “food and drink” and period “March 1-March 31” exists in the priority master 12. Since the priority master 12 shown in FIG. 3 does not include the information having both of “food and drink” and “March 1-March 31”, it is judged that the received offer does not correspond to a priority offer, in which the priority master includes “food and drink”, but, the period is “April 1-April 30” which is different from “March 1-March 31”.

When it is judged that the received offer does not correspond to any priority offer in the priority master 12, the process goes to step 15. When it is judged that the received offer corresponds to a priority offer in the priority master 12, the process goes to step 13.

In step 13, the matching program 15 obtains category data which is paired with category of the priority offer in the priority master. Then, the matching program 15 judges whether the discount data 13 includes a discount offer including the category data. For example, when a discount offer is received in which the category is “food and drink” and the period is “April 1-April 30”, since both data is included in the priority master 12, the matching program 15 obtains “transportation” which is the category data paired with “food and drink” in FIG. 3. The category data “transportation” should be included in a discount offer which is paired with the received offer preferentially. Then, the matching program 15 judges whether there is a discount offer which has “transportation” as category and which are not yet paired in the discount data 13.

When there is a discount offer which includes the category, the process goes to step 16, and when there is not the discount offer, the process goes to step 15. Step 15 is performed when the received offer is not included as a priority offer in the priority master 12, or when the received offer is included in the priority master 12 but any offer which is paired with the received offer preferentially does not exist.

In step 15, the matching program 15 judges whether there is a discount offer having a category which is different from that of the currently received offer in the discount data 13.

For example, in the case where only an offer of R001 is registered in the discount data 13 shown in FIG. 4, when offers from R002 to R004 are received at this time, the matching program 15 judges whether an offer which includes a category other than “recreation” is registered. The store ID of the offers from R002 to R004 is S002, and the category is recreation, the store name is a Z movie theater. In addition, a discount is 100 yen during a period from March 1 to April 30, and two discounts are during period from March 1 to March 31 which can be paired with two stores. Since the category of the request R001 is “food and drink” which is different from the “recreation” and the period of discount is the same between R001 and R002, the R001 is selected as a candidate which can be paired with R002.

As for a discount offer of R009 from W shobou having category “recreation”, although the discount period of R009 is the same as that of R003, since the category is the same as that of R003, the request R009 is not selected as a candidate which is paired with the offer R003 of the Z movie theater.

When there is no offer which can be paired with the received offer, it is judged that pairing is not available and the process for when pairing is not available in step 54 in FIG. 5 is performed.

When it is judged that there is a candidate which can be paired with the received offer in step 15, the process goes to step 16. The step 16 is a process for preventing that a store is paired with a plurality of stores having the same discount period and the same category.

More particularly, in step 16, it is checked whether there is any candidate offer in the candidates which have been selected by the step 15 in which a store of the candidate offer is paired with another store which has the same category of a store of the currently received offer, wherein the periods of the candidate offer, an offer of the another store and the currently received offer are the same. When there is such candidate offer, the candidate offer is excluded from a discount offer which is paired with the received offer.

For example, in the discount data 13 shown in FIG. 4, R003 and R009 can be listed as candidate offers for an offer R007 from A sushi since the offer R007 includes “food and drink” as the category which is different from “recreation” of R003 and R009, and the periods are the same. However, as a discount which has been paired for the Z movie theater (S002), the discount R001 has been paired with R002. Since the category of R001 is the same as that of R007, R003 is excluded from the candidate which can be paired with R007.

According to this step, it can be prevented that discount pairs like Z movie theater and X pizza, and, Z movie theater and A sushi exist in the same period so that competition relationship between the X pizza and the A sushi which have the same category “food and drink” can be considered.

After excluding inappropriate pairing candidate in step 16, the matching program 15 judges whether there are a plurality of candidates in step 17. When the number of the candidate is one, it is judged that the pair is established and the process goes to step 55 in FIG. 5.

When the number of the candidates is two or more, the process goes to step 18. The matching program 15 selects a store which is nearest to the store which sent the current discount offer in step 18.

For comparing the locations of the stores, the matching program searches the location field of the store master 11 by using store IDs in the discount data 13. When judging near or far of the stores, stores having the same location name can be judged to be near. In addition, distance between the stores can be used for the judgment by using software which handles a map on the basis of the location information.

By performing this step, since a discount pair can be established in which the paired stores are located near, discount can be realized in which users can easily use.

By performing the steps 11-18 by the matching program 15, a discount offer which is paired with a received discount offer can be selected uniquely, or information that there is no offer which can be paired can be obtained.

Information on each store in the store master 11 can be registered beforehand, or, the information can be registered by each store by displaying a login screen or a screen for new registration before displaying discount offer screen.

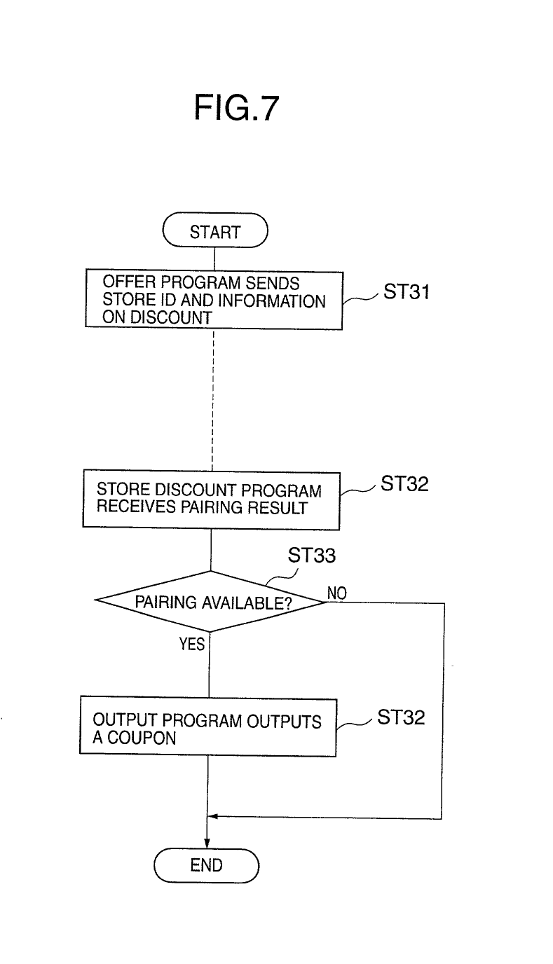

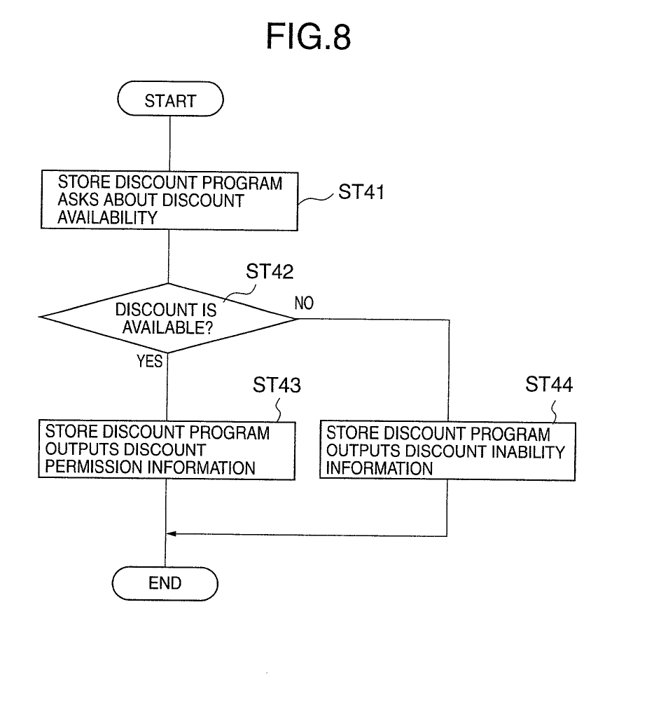

In the following, the operation of the client 3a will be described with reference to FIGS. 7 and 8. As mentioned above, the operations of the clients 3b and 3c are the same as that of the client 3a.

FIG. 7 shows a process from the time when the client 3a sends a discount offer to the server 1 to the time when the client 3a receives a result of pairing discounts.

The offer program 31 of the client 3a sends a store ID of itself and information on discount to the send/receive program 14 of the server 1 via the network 2. In this step, an operator of the client 3a inputs the store ID and the information on discount price and period from a screen as shown in FIG. 9 for example, then, the client 3a sends the input data as a discount offer.

When the client sends the discount offer in step 31, the process of offer ends temporarily.

The store discount program 33 receives information on availability of pairing for the discount offer from the send/receive program 14 of the server 1 in step 32. Then, the store discount program judges whether a pair for the discount offer has been established or not in step 33. When the pair is established, the process goes to step 34. When the pair is not established, the process ends.

In step 34, the output program 32 outputs a coupon on which information about discount is described. The information about discount includes information of a discount which is paired with the offered discount in a pair received in step 32, a discount period and a discount price. An operator of the client 3a of each store can provide information on discount to a user by distributing the coupon to the user when selling commodities. The user who received the coupon can get a discount by presenting this coupon when buying a commodity in another store which is paired with the store.

The discount provided in a store can be realized without using the coupon. In this case, availability of pairing is judged in step 33, and it is not necessary that the output program 32 outputs the coupon in step 34. In addition, for example, the output program 32 may output information about discount on a receipt which is handed to a user when selling a commodity.

FIG. 8 shows an example of a process when discount is performed while the client does not issue the coupon to the user in the store. In this flowchart, a process is shown in which the user show a receipt of another store to a salesclerk as an evidence of purchase in the another store, then, the client asks the server 1 about availability of discount.

In step 41, the store discount program 33 asks the server 1 about the availability of discount via the network 2. When asking the availability, store IDs of itself and another store which is presented by the user are sent to the server 1.

The server 1 which receives information sent from the store discount program 33 judges whether the pair of stores are registered in the discount data 13 and the present time is within the discount period while the discount program 16 refers to the discount data 13. When the pair is registered and the present time is in the discount period, it is judged that discount is available. When this condition is not satisfied, it is judged that the discount is not available. The judgment result is sent to the client 3a.

Next, the store discount program 33 receives information on the judgment result from the discount program 16 of the server 1 via the send/receive program 14 and the network 2. When the discount is available, the output program 32 outputs information indicating that the discount is available to a display connected to the client 3a for example so that the operator is notified of the information in step 43. When the discount is not available, the process goes to step 44. Then, the output program 32 outputs information indicating that the discount is not available to a display connected to the client 3a for example so that the operator is notified of the information in step 44.

The operator of the client 3a can know whether the user can receive the discount by referring to the output information.

Since this method of paring discounts is realized in a server 1 which is a computer, proper pairs can be established for discount offers received from a plurality of stores on the basis of information of the category and the location. In addition, by referring to information in the priority master 12 in which information of offers which can be preferentially paired is registered, it can be precisely controlled how a pair is established for each offer.

That is, by preventing stores having the same category from being paired, it becomes possible to revitalize an area and the whole shopping street while considering relationships between competing stores in member stores. In addition, by establishing a pair such that a store is paired with another store which is nearest to the store, it becomes possible to encourage purchases by users.

In addition, by considering information on candidates which can be paired with a discount offer preferentially, the sales direction of the area and the shopping street can be reflected to discounts.

Further, since the method of pairing discounts of the present invention is realized on the client which is a computer, each store can offer discounts, receive availability of establishment of a pair for the discount offer, and allows a discount for a user in a store.

The present invention is not limited to the above-mentioned configuration. For example, a system of the present invention can be configured such that the server 1, instead of the client 3a, outputs a coupon according to an established discount pair. In addition, the system can be configured such that the client 3a stores information of discount pairs established by the server 1 such that the client 3a judges whether discount is available by referring to the pair information.

In addition, when providing a mediation service between stores by using the method of pairing discounts of the present invention, a part used for obtaining profits, wherein a commission is paid from a store which offered a discount according to establishment of the pair, and a charge is paid according to the number of users who use this service.

The server 1 is a computer, which is not shown in the figure, which is controlled by a CPU (Central Processing Unit). A RAM (Random Access Memory), a hard disk device (HDD), a graphic processing part, an input interface and a communication interface and the like are connected to the CPU via a bus.

At least a part of a program for OS (operating System) or other programs is stored in the RAM temporarily. In addition, various data necessary for processing by the CPU is stored in the RAM. The OS and the other programs and data are stored in the HDD.

A monitor device is connected to the graphic processing part. The graphic processing part allows the monitor device to display an input screen and the like according to instructions from the CPU. A keyboard and a mouse are connected to the input interface. The input interface sends a signal sent from the keyboard or the mouse to the CPU via the bus.

The communication interface is connected to the network 2. The communication interface sends/receives an e-mail or a web screen with the client 3a via the network 2. The clients 3a-3c have the same hardware configuration as the server 1.

By executing a program for pairing discounts of the present invention in the above-mentioned computer, the computer can be used as a discount pairing apparatus.

In addition, processes for functions of the computer can be represented by a program which can be stored in a computer readable medium. By executing the program on a computer, the processes can be performed in the computer. As the computer readable medium, there are a magnetic recording device and a semiconductor memory and the like. In addition, by storing the program in a transportable storing medium such as a CD-ROM or a floppy disk, the program can be distributed. In addition, by storing the program in a storing device in a computer which is connected to a network, the program can be transferred to another computer via a network. When executing the program in the computer, the program is loaded in a main memory from a hard disk device in the computer so that the program is executed.

According to the present invention, a user who bought a commodity in a store is allowed to receive a discount in another store on the basis of information of a pair of the store and the another store.

In addition, since it is determined whether a discount and another discount are paired according to categories of stores of the discount and the another discount, it becomes possible that pairing of stores having the same category, which are competing stores, can be avoided, and, stores having different categories can be paired.

In addition, since it is determined whether a discount and another discount are paired according to relationship between locations of stores of the discount and the another discount, a pair of stores which are near can be established. Therefore, stores in an area can mutually attract more customers.

Further, according to the present invention, since each store can establish a discount freely, sales strategy can be maintained for each store. In addition, since discounts from a plurality of stores are paired, purchases by users are promoted in a plurality of stores so that local stores are activated.

In addition, as mentioned above, since a pair of discounts which are offered by each store is determined according to category of commodities and location of stores, relationships between competing stores which deal in commodities of the same category can be considered. In addition, a synergistic effect between neighboring stores arises. Therefore, more customers can be expected than sales promotion is performed by each stores individually. As a result, the area and the whole shopping street can be activated.

The present invention is not limited to the specifically disclosed embodiments, and variations and modifications may be made without departing from the scope of the invention.

What is claimed is:

1. A method used for pairing discounts on a network, said method comprising the steps of:
receiving a first offer of a first discount from a first store;
receiving a second offer of a second discount from a second store; and
pairing said first discount and said second discount, and registering a pair of said first discount and said second discount in a storing part.

2. The method as claimed in claim 1, further comprising the steps of:
allowing a user who bought a commodity in said first store to receive a discount in said second store on the basis of information of said pair.

3. The method as claimed in claim 1, wherein it is determined whether said first discount and said second discount are paired according to categories of said first store and said second store.

4. The method as claimed in claim 1, wherein said first discount and said second discount are not paired when categories of said first store and said second store are the same.

5. The method as claimed in claim 1, wherein a third discount of a third store is paired with a discount of said first store, and, said first discount and said second discount are not paired when categories of said second store and said third store are the same.

6. The method as claimed in claim 1, wherein it is determined whether said first discount and said second discount are paired according to relationship between locations of said first store and said second store.

7. The method as claimed in claim 1, wherein said first discount and said second discount are paired preferentially when said first store and said second store are located near.

8. The method as claimed in claim 1, said method further comprising the steps of:
determining whether a third offer of a third discount corresponds to a priority offer by referring to a priority master;
searching discount data for a fourth discount of a fourth store having a category which is paired with a category of said third discount in said priority master when said third offer corresponds to said priority offer; and
paring said third discount and said fourth discount.

9. A method used for pairing discounts on a network, said method comprising the steps of:
sending an offer of a first discount from a first store; and
receiving information on a pair of said first discount and a second discount of a second store in response to sending said offer.

10. An apparatus used for pairing discounts on a network, said apparatus comprising:
a part receiving a first offer of a first discount from a first store;
a part receiving a second offer of a second discount from a second store; and
a part pairing said first discount and said second discount, and registering a pair of said first discount and said second discount in a storing part.

11. The apparatus as claimed in claim 10, further comprising:
a part allowing a user who bought a commodity in said first store to receive a discount in said second store on the basis of information of said pair.

12. The apparatus as claimed in claim 10, wherein it is determined whether said first discount and said second discount are paired according to categories of said first store and said second store.

13. The apparatus as claimed in claim 10, wherein it is determined whether said first discount and said second discount are paired according to relationship between locations of said first store and said second store.

14. An apparatus used for pairing discounts on a network, said apparatus comprising:
a part sending an offer of a first discount from a first store; and
a part receiving information on a pair of said first discount and a second discount of a second store in response to sending said offer.

15. A computer readable medium storing program code for causing a computer to pair discounts on a network, said computer readable medium comprising:
program code means for receiving a first offer of a first discount from a first store;
program code means for receiving a second offer of a second discount from a second store; and
program code means for pairing said first discount and said second discount, and registering a pair of said first discount and said second discount in a storing part.

16. The computer readable medium as claimed in claim 15, further comprising:
program code means for allowing a user who bought a commodity in said first store to receive a discount in said second store on the basis of information of said pair.

17. The computer readable medium as claimed in claim 15, wherein it is determined whether said first discount and said second discount are paired according to categories of said first store and said second store.

18. The computer readable medium as claimed in claim 15, wherein it is determined whether said first discount and said second discount are paired according to relationship between locations of said first store and said second store.

19. A computer readable medium storing program code for causing a computer to pair discounts on a network, said computer readable medium comprising:
program code means for sending an offer of a first discount from a first store; and
program code means for receiving information on a pair of said first discount and a second discount of a second store in response to sending said offer.

20. A computer program for causing a computer to pair discounts on a network, said computer program comprising:
program code means for receiving a first offer of a first discount from a first store;
program code means for receiving a second offer of a second discount from a second store; and
program code means for pairing said first discount and said second discount, and registering a pair of said first discount and said second discount in a storing part.

21. The computer program as claimed in claim 20, further comprising:
program code means for allowing a user who bought a commodity in said first store to receive a discount in said second store on the basis of information of said pair.

22. The computer program as claimed in claim 20, wherein it is determined whether said first discount and said second discount are paired according to categories of said first store and said second store.

23. The computer program as claimed in claim 20, wherein it is determined whether said first discount and said second discount are paired according to relationship between locations of said first store and said second store.

24. A computer program for causing a computer to pair discounts on a network, said computer readable medium comprising:
program code means for sending an offer of a first discount from a first store; and
program code means for receiving information on a pair of said first discount and a second discount of a second store in response to sending said offer.
